(19) United States
(12) Patent Application Publication
(10) Pub. No.: US 2009/0026953 A1
(43) Pub. Date: Jan. 29, 2009

(54) MANUFACTURING METHOD OF PLASMA DISPLAY PANEL AND PLASMA DISPLAY PANEL

(75) Inventor: Hideki Harada, Miyazaki (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/173,089

(22) Filed: Jul. 15, 2008

(30) Foreign Application Priority Data
Jul. 24, 2007 (JP) 2007-192535

(51) Int. Cl. H01J 17/49; H01J 9/00; H01J 9/24

(52) U.S. Cl. 313/582; 445/24; 445/25

(57) ABSTRACT

A PDP (plasma display panel) is manufactured by a manufacturing method including the steps of: (a) preparing a front structure (first structure) having a plurality of X electrodes (first electrodes) and Y electrodes (first electrodes) formed on one surface of a front substrate (first substrate) and a dielectric layer that covers the X electrodes and the Y electrodes and a rear structure (second structure) having a plurality of address electrodes (second electrodes) and a plurality of barrier ribs formed on one surface of a rear substrate (second substrate); (b) forming a protective layer containing SrCO₃ (strontium carbonate) on a surface of the dielectric layer of the front structure; and (c) assembling the front structure and the rear structure, wherein the step (c) includes a transforming step in which the protective layer is formed by transforming at least a part of SrCO₃ contained therein to SrO (strontium oxide).

### CROSS-REFERENCE TO RELATED APPLICATION

The present application claims priority from Japanese Patent Application No. JP 2007-192535 filed on Jul. 24, 2007, the content of which is hereby incorporated by reference into this application.

### TECHNICAL FIELD OF THE INVENTION

The present invention relates to a technology for a plasma display. In particular, it relates to a technology effectively applied to a plasma display panel having a protective layer formed on a surface of a dielectric layer formed on at least one substrate.

### BACKGROUND OF THE INVENTION

A plasma display panel (PDP) is a display panel in which a gas discharge is generated in a discharge space called a cell filled with a discharge gas such as a rare gas and phosphors are excited by vacuum ultraviolet rays generated at the time of this discharge, thereby displaying an image.

In general, the PDP has a structure in which paired substrates are fixed in a state of being faced with each other. Electrodes and a dielectric layer that covers the electrodes are formed on at least one of these substrates. Also, a protective layer for protecting the dielectric layer from collision (sputter) of ions generated by electrolytic dissociation by plasma is formed on a surface of the dielectric layer.

When electrons and ions generated by electrolytic dissociation collide with this protective layer, secondary electrons are emitted from the protective layer. By increasing a secondary electron emission coefficient of the protective layer, the firing voltage can be reduced. In other words, power consumption at the time of driving the PDP can be reduced.

Therefore, MgO (magnesium oxide) with a secondary electron emission coefficient higher than that of metals is generally used for the protective layer. Also, in order to further reduce the firing voltage, various materials to form the protective layer have been suggested.

For example, Japanese Patent Application Laid-Open Publication No. 2007-12436 (Patent Document 1) discloses a plasma display panel using SrCaO, which is a complex compound of Ca and Sr, as a protective layer.

Also, for example, Japanese Patent Application Laid-Open Publication No. 10-149767 (Patent Document 2) discloses a plasma display panel using SrO as a protective layer.

### SUMMARY OF THE INVENTION

The inventor of the present invention has studied the technologies capable of reducing the firing voltage of the plasma display and has found the following problems.

Metal oxide used for the protective layer has a property of easily absorbing moisture in air. When moisture is absorbed in a metal oxide, the metal oxide reacts with water to be deliquesced or transformed to a metal hydroxide compound. This metal hydroxide compound is significantly inferior to metal oxides in sputter resistance and secondary electron emission coefficient. Therefore, the crystal structure of the protective layer tends to be destroyed by sputter. Also, it becomes disadvantageously impossible to reduce a firing voltage.

To get around these problems, for example, the above-mentioned Japanese Patent Application Laid-Open Publication No. 2007-12436 (Patent Document 1) suggests a method of suppressing moisture absorption of the protective layer by sealing the discharge space in a vacuum (reduced pressure atmosphere) or in an inert gas.

However, the studies by the inventor of the present invention have revealed that hygroscopicity of SrO is particularly higher than that of MgO, and for example, even in a reduced pressure atmosphere (high vacuum atmosphere) of about 1×10⁻⁴ Pa, SrO absorbs slight moisture in the atmosphere to be deliquesced or transformed to Sr(OH)₂, which is a metal hydroxide compound. Also, even when the sealing is performed in an inert gas, SrO is deliquesced or transformed to Sr(OH)₂ if even a slight partial pressure of moisture is present in the inert gas (for example, about 1×10⁻⁴ Pa).

For this reason, it is difficult to apply this method to a PDP mass-production line.

Also, Japanese Patent Application Laid-Open Publication No. 10-149767 (Patent Document 2) suggests a method in which a primary protective film made of MgO that covers the protective layer is formed, and after assembly of the PDP, plasma is generated inside the PDP to remove the primary protective film. According to this method, absorption of moisture in the protective layer during PDP assembling step can be prevented.

However, the studies by the inventor of the present invention have revealed that there is the possibility in this method that a part of the primary protective film may remain even if plasma is generated, and if a part of the primary protective film remains, the firing voltage may possibly be fluctuated with time. Such fluctuations of the firing voltage result in the impairment of PDP reliability.

As described above, since SrO has a high secondary electron emission coefficient in comparison with MgO, the firing voltage can be reduced. However, since SrO has a high hygroscopicity, it is disadvantageously impossible to keep a stably low firing voltage.

The present invention has been devised in view of the above-described problems, and an object of the present invention is to provide a technology capable of reducing power consumption at the time of driving the PDP.

The typical ones of the inventions disclosed in this application will be briefly described as follows.

More specifically, a manufacturing method of a plasma display panel according to the present invention comprises the steps of:

(a) preparing a first structure having a plurality of first electrodes formed on one surface of a first substrate and a dielectric layer that covers the first electrodes and a second structure having a plurality of second electrodes and a plurality of barrier ribs formed on one surface of a second substrate;

(b) forming a protective layer containing SrCO₃ (strontium carbonate) on a surface of the dielectric layer of the first structure; and

(c) assembling the first structure and the second structure,

wherein the step (c) includes a transforming step of transforming at least a part of SrCO₃ contained in the protective layer to SrO (strontium oxide).

The effects obtained by typical aspects of the present invention will be briefly described below. That is, power consumption at the time of driving the PDP can be reduced.

### BRIEF DESCRIPTIONS OF THE DRAWINGS

These and other features, objects and advantages of the present invention will become more apparent from the following description when taken in conjunction with the accompanying drawings wherein:

FIG. 1 is an enlarged perspective view showing main parts of a PDP according to the first embodiment of the present invention in an enlarged manner;

FIG. 2 is an enlarged cross-sectional view of main parts showing the state where a front structure and a rear structure shown in FIG. 1 are assembled;

FIG. 3 is an enlarged perspective view of main parts showing the structure of the front structure prepared in advance in the manufacturing method of a PDP according to the first embodiment of the present invention;

FIG. 4 is an enlarged perspective view of main parts showing the structure of the rear structure prepared in advance in the manufacturing method of a PDP according to the first embodiment of the present invention;

FIG. 5 is an enlarged perspective view of main parts showing the state where a protective layer is formed on the front structure shown in FIG. 3;

FIG. 6 is an enlarged cross-sectional view of main parts showing the structure of a peripheral portion of a panel structure obtained by assembling the front structure and the rear structure in the manufacturing method of a PDP according to the first embodiment of the present invention;

FIG. 7 is an enlarged cross-sectional view of main parts showing main parts of a PDP according to the third embodiment of the present invention in an enlarged manner;

FIG. 8 is an enlarged cross-sectional view of main parts showing main parts of a PDP according to the third embodiment of the present invention in an enlarged manner;

FIG. 9 is a plan view of a PDP apparatus according to the fifth embodiment of the present invention seen from a display surface side;

FIG. 10 is a plan view of the PDP apparatus shown in FIG. 9 when seen from a side of a surface (rear surface) opposite to a display surface;

FIG. 11 is a plan view showing the state where a front frame cover (external casing) is removed from the PDP apparatus shown in FIG. 9; and

FIG. 12 is a plan view showing the state where a rear cover (external casing) is removed from the PDP apparatus shown in FIG. 10.

### DESCRIPTIONS OF THE PREFERRED EMBODIMENTS

Components having the same function are denoted by the same reference numbers throughout the drawings for describing the embodiments, and the repetitive description thereof will be omitted. Hereinafter, embodiments of the present invention will be described in detail with reference to the accompanying drawings.

### First Embodiment

<PDP Structure>

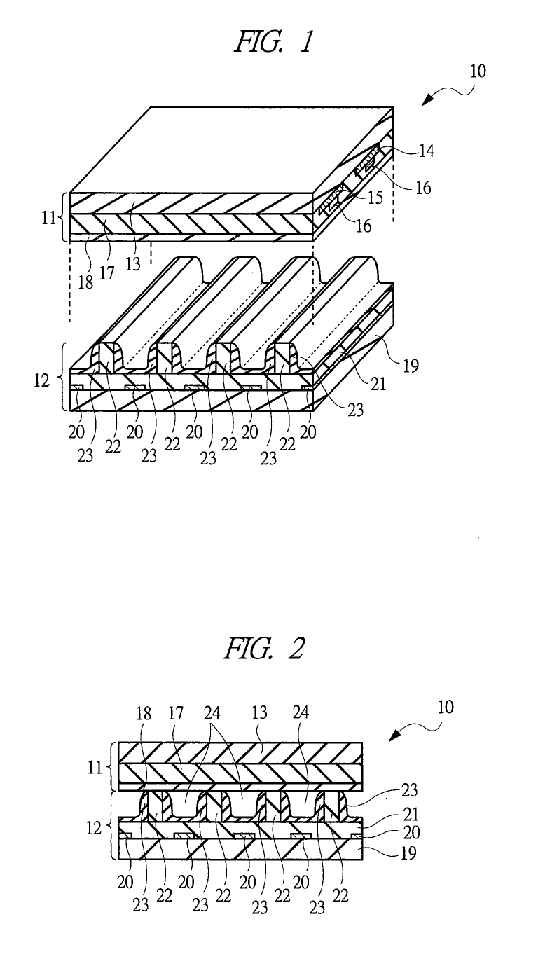

First, the structure of a PDP according to a first embodiment will be described with reference to FIG. 1 and FIG. 2, with using an alternating-current surface discharge type PDP as an example. FIG. 1 is an enlarged perspective view showing main parts of the PDP according to the first embodiment in an enlarged manner. FIG. 2 is an enlarged cross-sectional view of main parts showing the state where a front structure and a rear structure shown in FIG. 1 are assembled. Note that, for easy description of the structure of the PDP, FIG. 1 shows the state where the front structure and the rear structure are away from each other more than a predetermined space.

In FIG. 1, a PDP 10 has a front structure (first structure) 11 and a rear structure (second structure) 12. The front structure 11 and the rear structure 12 are combined together in a state of being faced with each other.

The front structure 11 has a display surface of the PDP 10 and has a front substrate (first substrate) 13 mainly made of glass on a display surface side. On a surface opposite to the display surface of the front substrate 13, a plurality of X electrodes (first electrodes) 14 and Y electrodes (first electrodes) 15 for performing sustain discharge are formed. Since these X electrodes 14 and Y electrodes 15 are formed on the display surface side of the PDP 10, they are made of a transparent electrode material.

The X electrodes 14 and Y electrodes 15 are formed so as to extend along a lateral (row) direction. Also, the X electrodes 14 and Y electrodes 15 are alternately arranged at a predetermined arrangement interval in a longitudinal (column) direction that crosses their extending direction. Also, each of the X electrodes 14 and each of the Y electrodes 15 are arranged so as to be parallel to each other. In the PDP 10, a pair of one X electrode 14 and one Y electrode 15 forms a display row.

Also, a bus electrode 16 is formed on each of the X electrodes 14 and the Y electrode 15. For the reduction of electrical resistance of the X electrode 14 and the Y electrode 15, the bus electrode 16 is made of a metal material.

A group of these electrodes (X electrodes 14, Y electrodes 15 and bus electrodes 16) are covered with a dielectric layer (first dielectric layer) 17. The dielectric layer 17 is made of, for example, a material called a low-melting glass mainly containing lead oxide and is formed to have a thickness of 25 μm.

Also, a protective layer 18 is formed on the surface of the dielectric layer 17. The protective layer 18 is formed so as to cover one surface of the dielectric layer 17. The structure of the protective layer 18 will be described further below in detail.

On the other hand, the rear structure 12 has a rear substrate (second substrate) 19 mainly made of glass. On the rear substrate 19, a plurality of address electrodes (second electrodes) 20 are formed. Each of the address electrodes 20 is formed so as to extend in a longitudinal (column) direction that crosses (at approximately a right angle) the direction in which the X electrodes 14 and the Y electrodes 15 extend. Also, the address electrodes 20 are arranged at a predetermined arrangement interval so as to be parallel to each other.

The address electrodes 20 are covered with a dielectric layer (second dielectric layer) 21. On the dielectric layer 21, a plurality of barrier ribs 22 extending in a thickness direction of the rear structure 12 are formed. The barrier ribs 22 are formed so as to extend in line along a direction in which the address electrodes 20 extend. Also, the planar position of each barrier rib 22 is located between adjacent address electrodes 20. By arranging each barrier rib 22 between the adjacent address electrodes 20, spaces to partition the surface of the dielectric layer 21 in a column direction are formed so as to correspond to the positions of the address electrodes.

Furthermore, an upper surface of the dielectric layer 21 on each address electrode 20 and side surfaces of each barrier rib 22 are coated with phosphors 23 that are excited by ultraviolet rays to emit the visible lights of red (R), green (G) and blue (B).

In the PDP 10, one cell is configured so as to correspond to an intersection of one pair of the X electrode 14 and the Y electrode 15 and the address electrode 20. Also, a set of the cells of R, G and B forms a pixel.

Next, as shown in FIG. 2, the front structure 11 and the rear structure 12 are fixed in a state where the surface on which the protective layer 18 is formed and the surface on which the barrier ribs 22 are formed are faced with each other. The protective layer 18 and the barrier ribs 22 are fixed in a state of being in at least partially contact with each other.

By fixing the protective layer 18 and the barrier ribs 22 in a state of being in contact with each other, a discharge space 24 partitioned by the protective layer 18 and the barrier ribs 22 is formed, and a surface on a rear structure 12 side (bottom surface and both side surfaces) of the discharge space 24 is coated with the phosphors 23. This discharge space 24 is filled with a gas called a discharge gas (for example, mixed gas of Ne and Xe) at a predetermined pressure.

The PDP 10 generates a discharge for each cell in the discharge space 24 to excite the phosphors 23 of R, G and B by vacuum ultraviolet rays generated by the discharge, thereby emitting light.

Here, the protective layer 18 provided in the PDP 10 has two functions.

The first function is to protect the dielectric layer 17 from collision (sputter) of ions generated by electrolytic dissociation at the time of discharge. The dielectric layer 17 is made of, for example, a material called a low-melting glass mainly containing lead oxide, and when the dielectric layer 17 is subjected to sputter, lead oxide is reduced to metal lead and the discharge voltage is increased. For its prevention, the protective layer 18 is formed to cover the dielectric layer 17 so that the dielectric layer 17 is not exposed to the discharge space 24.

Also, if sputter resistance of the protective layer 18 itself is low, the protective layer 18 is destroyed by the sputter and a part of the dielectric layer 17 is exposed in some cases. Thus, by improving the sputter resistance of the protective layer 18, the product life of the PDP 10 can be improved.

The second function is to reduce the firing voltage by emitting secondary electrons from the protective layer 18. When ions collide with the protective layer 18, secondary electrons are emitted, and these emitted secondary electros further collide with ions and others to cause secondary electrons to be emitted. When the secondary electron emission coefficient of the protective layer 18 is high (secondary electrons are easily emitted), such chains of secondary electron emission occur at many locations in the discharge space 24. Therefore, the voltage required for discharge, that is, the firing voltage can be reduced.

For the protective layer having the above-described functions, MgO (magnesium oxide) is generally used. However, the protective layer 18 according to the first embodiment is mainly made of SrO (strontium oxide). SrO has a secondary electron emission coefficient higher than that of MgO and thus can reduce the firing voltage. Specifically, compared with the case of replacing the protective layer 18 by a layer made of a single element of MgO, the firing voltage can be reduced by about 30 V.

Here, the protective layer 18 is mainly made of SrO, and it also contains SrCO₃ (strontium carbonate) resulting from the manufacturing method of the PDP 10. The amount of SrCO₃ in the protective layer 18 is larger on a surface side of the protective layer 18 in contact with the dielectric layer 17. On the other hand, no SrCO₃ is contained on a surface side of the protective layer 18 in contact with the discharge space 24, and the surface on that side is made of SrO. The reason why the protective layer 18 has such a structure will be described in detail further below together with the description of the manufacturing method of the PDP 10.

Further, when an Sr element is to be contained in a protective layer, the Sr element is contained as an additive into a protective layer mainly made of MgO in some cases. However, the protective layer 18 according to the first embodiment is mainly made of SrO and SrCO₃. Here, the main component of the protective layer 18 means a metal element contained at the largest ratio among all metal elements contained in the protective layer 18. In the first embodiment, an Sr element is the main component of the protective layer 18.

Meanwhile, the PDP 10 can take various structures depending on required performance and driving method thereof. The structure of the PDP 10 according to the first embodiment is not limited to that shown in FIG. 1 and FIG. 2. By way of example, FIG. 1 shows an example in which the discharge space is partitioned by the barrier ribs 22 extending in line (vertical direction).

However, for the purpose of increasing luminance or others, the discharge space may be partitioned by barrier ribs arranged in a lattice shape. The PDP 10 according to the first embodiment can take such a structure.

<Manufacturing Method of PDP>

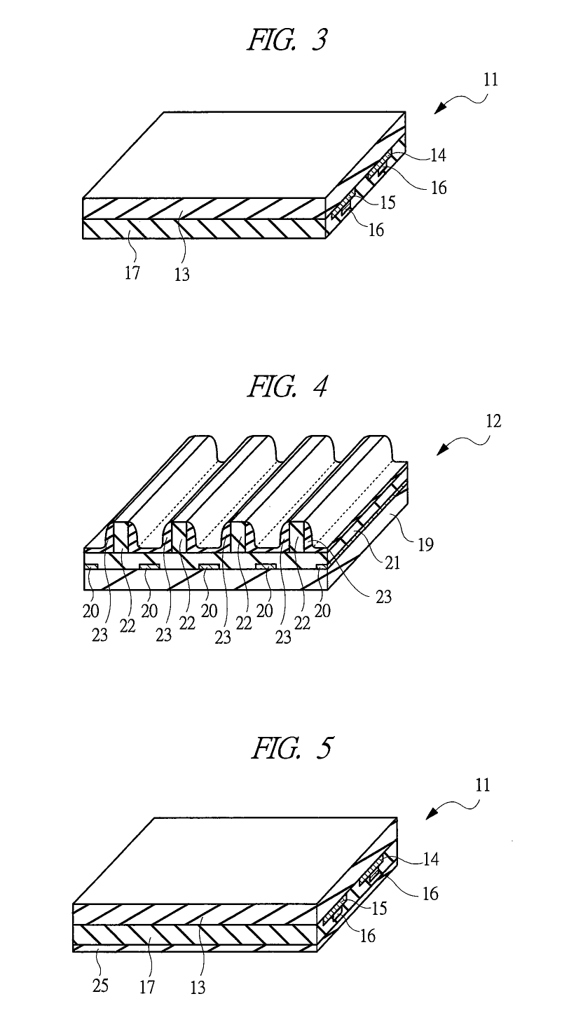

Next, the manufacturing method of the PDP 10 according to the first embodiment will be described with reference to FIG. 3 to FIG. 6. FIG. 3 is an enlarged perspective view of main parts showing the structure of the front structure prepared in advance in the manufacturing method of a PDP according to the first embodiment. FIG. 4 is an enlarged perspective view of main parts showing the structure of the rear structure prepared in advance in the manufacturing method of a PDP according to the first embodiment.

FIG. 5 is an enlarged perspective view of main parts showing the state where the protective layer is formed on the front structure shown in FIG. 3. FIG. 6 is an enlarged cross-sectional view of main parts showing the structure of a peripheral portion of a panel structure obtained by assembling the front structure and the rear structure in the manufacturing method of a PDP according to the first embodiment.

(a) First, the front structure (first structure) 11 shown in FIG. 3 is prepared. The front structure 11 shown in FIG. 3 is fabricated in advance in the following manner.

First, the front substrate 13 is prepared, and the X electrodes 14 and the Y electrodes 15 are formed with a predetermined pattern on one surface of the front substrate 13. Also, the bus electrode 16 is formed on each of the X electrodes 14 and the Y electrodes 15. Next, the dielectric layer 17 is formed on the front substrate 13 so as to cover the X electrodes 14, the Y electrodes 15 and the bus electrodes 16. At this stage, the protective layer 18 shown in FIG. 1 is not yet formed on the front structure 11.

Also, the rear structure (second structure) 12 shown in FIG. 4 is prepared. The rear structure 12 shown in FIG. 4 is fabricated in advance in the following manner.

First, the rear substrate 19 is prepared, and the address electrodes 20 are formed with a predetermined pattern on one surface of the rear substrate 19. Next, the dielectric layer 21 is formed on the surface of the rear substrate 19 so as to cover the address electrodes 20. Then, the barrier ribs 22 defining the discharge spaces are formed on the surface of the dielectric layer 21. The barrier ribs 22 are formed so as to extend along the address electrodes 20.

Note that the rear structure 12 is not necessarily provided at this stage and can be provided at least before an assembling step (c) described further below.

(b) Next, as a protective-layer forming step, a protective layer (temporary protective layer) 25 shown in FIG. 5 is formed on the surface of the dielectric layer 17 of the front structure 11. The protective layer 25 is made of SrCO₃ and can be formed by, for example, vapor deposition. In the first embodiment, the protective layer 25 having a thickness of 1 μm is formed on the surface of the dielectric layer 17 by a vacuum deposition method with electron beams using an SrCO₃ source as a target.

Here, the protective layer 18 shown in FIG. 1 is mainly made of SrO which is a metal oxide. Since the metal oxide has a property of easily absorbing moisture and others in an atmosphere, if the metal oxide is formed on the surface of the dielectric layer 17 at this stage, the surface of the metal oxide may react with moisture and others to be transformed at the steps subsequent to this step.

In particular, SrO has a hygroscopicity higher than that of MgO which is also a metal oxide, and even if subsequent steps are performed in a reduced pressure atmosphere (high vacuum atmosphere) of about 1×10⁻⁴ Pa, SrO absorbs slight moisture in the atmosphere.

On the other hand, SrCO₃ used for the protective layer 25 according to the first embodiment has a high stability in the air compared with SrO (even compared with MgO). More specifically, SrCO₃ hardly absorbs or reacts with moisture and others in the air.

Therefore, for example, even if the steps subsequent to the protective-layer forming step (steps until the transforming step described later) are performed in an air atmosphere, the transformation of the protective layer 25 can be suppressed or prevented. Also, if the steps subsequent to the protective-layer forming step are performed in a vacuum (reduced pressure) atmosphere, the transformation of the protective layer 25 can be more reliably prevented.

(c) Next, the PDP 10 shown in FIG. 1 is assembled. The rear structure 12 shown in FIG. 4 and the front structure 11 shown in FIG. 5 are assembled in the following manner.

(c1) First, in an aligning step, as shown in FIG. 6, the front structure 11 and the rear structure 12 are aligned in a state where the surface of the front structure 11 on which the protective layer 25 is formed and the surface of the rear structure 12 on which the barrier ribs 22 are formed are faced with each other. In the aligning step, adjustment is made so that the X electrodes 14 (refer to FIG. 5) and the Y electrodes 15 (refer to FIG. 5) of the front structure 11 and the address electrodes 20 of the rear structure 12 have a predetermined positional relation.

When the aligning step is performed in a vacuum (reduced pressure) atmosphere, the operation is complex and thus requires time for alignment. According to the first embodiment, however, the aligning step can be performed in an air atmosphere, and therefore, the time required for alignment can be shortened and the manufacturing efficiency can be improved. Also, since no vacuum chamber is required, the downsizing of the manufacturing apparatus can be achieved.

(c2) Next, in a sealing step, peripheral portions of the front structure 11 and the rear structure 12 are sealed. In the sealing step, an adhesive 26 such as a low-melting glass is applied onto one peripheral portion of the front structure 11 and the rear structure 12 (application of the adhesive 26 is preferably performed before the aligning step), and then the adhesive 26 is heated, thereby sealing the front structure 11 and the rear structure 12.

By the cooling after the sealing, the adhesive 26 is cured to fix the front structure 11 and the rear structure 12 with the predetermined positional relation. In the first embodiment, a heating temperature of 450° C. is kept for ten minutes in the sealing step.

After the end of this sealing step, the peripheral portions of the front structure 11 and the rear structure 12 are sealed together, thereby forming a panel structure 27 of an integrated structure. However, a hole 28 penetrating through the front structure 11 or the rear structure 12 is formed at least one or more positions inside the region sealed with the adhesive 26 (FIG. 6 shows an example in which the hole 28 is formed in the front structure 11).

Also, a tip tube (ventilating means) 29 such as a glass tube is fixed in alignment with this hole 28. At the stage of the end of the sealing step, the tip tube 29 is in an open state. The discharge space 24 is not completely shut off from the outside of the panel structure 27, but ventilation from and to the outside of the panel structure 27 (gas intake from outside or gas exhaust to outside) is possible through this tip tube 29.

(c3) Next, in a transforming step, SrCO₃ forming the protective layer 25 is transformed to SrO. SrCO₃ has a property that it is decomposed into SrO and CO₂ when ignited. In the first embodiment, for utilizing this SrCO₃ property, the temperature is kept at 450° C. for five minutes. In detail, ten minutes which is a keeping time in the sealing step is extended by five minutes.

In this transforming step, at least a part of SrCO₃ of the protective layer 25 is transformed to SrO. In particular, on a surface side of the protective layer 25 (the surface of the protective layer 25 in contact with the discharge space 24), the entire SrCO₃ is transformed to SrO. On the other hand, on a surface side of the protective layer 25 in contact with the dielectric layer 17, a part of SrCO₃ remains untransformed to SrO. More specifically, in the transforming step, the protective layer 25 shown in FIG. 6 can be transformed to the protective layer 18 described with reference to FIG. 1 and FIG. 2.

In this transforming step, CO₂ is generated when SrCO₃ is decomposed into SrO. This CO₂ is exhausted through a ventilation path (not shown) connected to the tip tube 29 to the outside of the panel structure 27.

Here, as a modification example of the transforming step according to the first embodiment, the following method can be used. After the sealing step, in a state where the protective layer 25 is being heated (for example, kept at 450° C.), an O₂ (oxygen) gas is introduced into the discharge space 24. After the introduction of the O₂ gas, the ventilation path connected to the tip tube 29 is temporarily shut off and kept for, for example, five minutes. After the end of the transforming step to SrO, the O₂ gas is exhausted together with CO₂ through the ventilation path connected to the tip tube 29 to the outside of the panel structure 27.

By the introduction of an O₂ gas, oxidation of SrCO₃ forming the protective layer 25 is promoted, and more efficient transformation to SrO can be achieved. The studies by the inventor of the present invention have revealed that, when an O₂ gas is introduced, the ratio of remaining SrCO₃ is lowered compared with the case where the keeping time is simply extended by five minutes. In detail, when an O₂ gas is introduced, SrCO₃ slightly remains on the surface of the protective layer 25 in contact with the dielectric layer 17, but almost the entire protective layer 25 is transformed to SrO.

By transforming almost the entire protective layer 25 to SrO, the crystal structure inside the layer can be made strong. In other words, sputter resistance of the protective layer 18 (refer to FIG. 1) can be improved, and thus the product life of the PDP 10 (refer to FIG. 1) can be extended.

Meanwhile, the case where SrCO₃ remains in a part of the protective layer 25 has been described in the present embodiment. According to the first embodiment, however, by further extending the time to keep the protective layer 25 in a heated state, SrCO₃ can be completely transformed to SrO. In this case, the protective layer 18 after the transforming step (refer to FIG. 1) is characterized in that SrO forming the protective layer 18 is obtained by transforming SrCO₃.

However, even if SrCO₃ remains only slightly on the surface side of the protective layer 25 in contact with the dielectric layer 17, it does not particularly pose any problems in effect in view of the product life or the reduction in the firing voltage. Therefore, in order to reduce the time required for the transforming step to improve the manufacturing efficiency, the transforming step preferably ends in a state where SrCO₃ partly remains.

(c4) Next, in a discharge-gas introducing step, a predetermined discharge gas is introduced into the discharge space 24 through the ventilation path connected to the tip tube 29. Before the introduction of the discharge gas, the remaining gas in the discharge space 24 is exhausted in advance.

In the first embodiment, the remaining gas in the discharge space 24 is exhausted by using a vacuum pump as exhausting means, and then a mixed gas of Ne and Xe (partial pressure ratio is 85:15) is introduced by using a gas feeding pump at 500 torr (approximately 67 kPa).

(c5) Finally, in a tip-tube sealing step, the opening of the tip tube 29 is sealed and cut, thereby completing the PDP 10 shown in FIG. 1 and FIG. 2.

<Evaluation of Firing Voltage of PDP 10>

Next, the results of evaluation of the firing voltage of the PDP 10 shown in FIG. 1 and FIG. 2 will be described. In this evaluation, in order to check an effect of reducing the firing voltage of the PDP 10, three types of PDP are prepared as comparison examples. Also, in a method of evaluating the firing voltage, a voltage is supplied to each of the PDPs and a voltage required for the PDP to light up is evaluated as the firing voltage. Furthermore, in order to check the durability of the PDP, after the PDP is lit up consecutively for 504 hours (three weeks) at 60 kHz, the voltage supply is once stopped, and then a voltage required for the PDP to light up again (hereinafter, referred to as a relight starting voltage) is measured.

As a first comparison example, a PDP in which the protective layer 18 shown in FIG. 1 is replaced by MgO is prepared. The difference between the first comparison example and the PDP 10 according to the first embodiment lies in that a film made of a single element of MgO is formed as a protective layer. Therefore, in the first comparison example, the transforming step (c3) described in the first embodiment is not performed. Also, the steps from the protective-layer forming step (b) to the tip-tube sealing step (c5) are performed under a reduced pressure atmosphere of 1×10⁻⁴ Pa.

An initial firing voltage of the first comparison example is 210 V, and a relight starting voltage is also 210 V.

Further, as a second comparison example, a PDP formed by a manufacturing method different from that of the PDP 10 is prepared. The difference between the second comparison example and the PDP 10 according to the first embodiment lies in that a film made of a single element of SrO is formed in the protective-layer forming step (b). Therefore, in the second comparison example, the transforming step (c3) described in the first embodiment is not performed. Also, the steps from the protective-layer forming step (b) to the tip-tube sealing step (c5) are performed under a high vacuum (reduced pressure) atmosphere of 1×10⁻⁴ Pa.

An initial firing voltage of the second comparison example is 180 V. However, a relight starting voltage is increased to 200 V. In checking the state of the protective layer according to the second comparison example, the crystal structure of a part of the protective layer (in particular, its surface) is destroyed. From this result, it has been found that, when a film made of a single element of SrO is formed in the protective-layer forming step (b), even if the subsequent steps up to the tip-tube sealing step (c5) are performed under a high vacuum (reduced pressure) atmosphere of 1×10⁻⁴ Pa, the surface of SrO is transformed.

Further, as a third comparison example, a PDP formed by a manufacturing method different from that of the PDP 10 is prepared. The difference between the third comparison example and the PDP 10 according to the first embodiment lies in that, after a film made of a single element of SrO is formed in the protective-layer forming step (b), a temporary protective film of MgO of 0.05 μm is successively formed on the surface of the protective layer and is then removed after the sealing step (c2). Therefore, in the third comparison example, in place of the transforming step (c3) described in the first embodiment, a step of generating plasma in the discharge space to remove the temporary protective film is performed. Also, the steps from the protective-layer forming step (b) to the tip-tube sealing step (c5) are performed under a high vacuum (reduced pressure) atmosphere of 1×10⁻⁴ Pa.

An initial firing voltage of the third comparison example is 180 V, and a relight starting voltage is also 180 V. However, when the PDP according to the third comparison example is left unlit at room temperature for one month and then a firing voltage is again evaluated, the firing voltage is increased to 200 V.

In checking the state of the protective layer according to the third comparison example, residues resulting from the removal of the temporary protective layer of MgO are attached on a part of the protective layer (in particular, its surface). From this result, it has been found that it is difficult to completely remove the temporary protective film, and if residues are left near the protective layer, the firing voltage fluctuates with time due to the influences of the residues.

Next, an initial firing voltage of the PDP 10 according to the first embodiment is 180 V and a relight starting voltage is also 180 V. Further, when the PDP 10 is left unlit at room temperature for one month and then a firing voltage is again evaluated in the same manner as the third comparison example, the firing voltage does not fluctuate, that is, remains 180 V.

More specifically, the PDP 10 can reduce the firing voltage by 30 V (approximately 14%) compared with the first comparison example. Therefore, the PDP 10 can reduce power consumption at the time of driving more than the first comparison example.

Also, unlike the second and third comparison examples, the firing voltage of the PDP 10 does not fluctuate with time. More specifically, the firing voltage can be stably reduced.

### Modification Example of First Embodiment

As a modification example of the first embodiment, the structure in which the protective layer 18 shown in FIG. 1 contains Ca (calcium) as an element can be used. In this case, Ca is contained as CaO (calcium oxide) or a complex of SrCaO in the protective layer 18.

By containing Ca as an element in the protective layer 18 in this manner, the sputter resistance of the protective layer 18 can be further improved, thereby further improving the product life of the PDP 10.

For example, a method of containing Ca as an element in the protective layer 18 can be achieved in the following manner. In the above-described protective-layer forming step (b), when the protective layer 25 is to be formed, a composite source of SrCO₃ and CaCO₃ is used as a target in the case of a vacuum deposition method. By using this composite source, SrCO₃ and CaCO₃ can be contained in the protective layer 25.

The subsequent steps to be performed are similar to those of the PDP 10. More specifically, the protective layer 25 containing SrCO₃ and CaCO₃ can be transformed to the protective layer 18 containing SrO, CaO or SrCaO in the transforming step (c3).

### Second Embodiment

In a second embodiment, a method of transforming SrCO₃ to SrO in a manner different from the method according to the first embodiment will be described. Note that the second embodiment is different from the first embodiment only in the transforming step (c3), and the structure of the PDP 10 is similar to that of the first embodiment. Therefore, in the second embodiment, description will be made with reference to FIG. 1 to FIG. 6 appropriately. Also, since the steps other than the transforming step (c3) described in the first embodiment can be applied to the second embodiment, the description of these steps other than the transforming step is omitted.

In the second embodiment, SrCO₃ contained in the protective layer 25 shown in FIG. 6 is transformed to SrO in the transforming step (c3) in the following manner.

(c3) After the end of the sealing step, the panel structure 27 including the protective layer 25 is cooled to room temperature (for example, 25° C.).

Next, after the remaining gas in the discharge space 24 is exhausted, an O₂ gas is introduced through a ventilation path connected to the tip tube 29. In the second embodiment, an O₂ gas of a partial pressure of 100% is introduced with a pressure of 1 torr (approximately 133 Pa), and then the ventilation path connected to the tip tube 29 is temporarily shut off.

Next, in a state where the discharge space 24 is filled with the O₂ gas, a predetermined voltage is supplied between electrode terminals of the X electrodes 14 (refer to FIG. 5) and the Y electrodes 15 (refer to FIG. 5) to generate a discharge, and the state of generating the discharge is kept for a predetermined time. In the second embodiment, a voltage of 230 V (60 kHz) is supplied between the electrode terminals, and the discharging state is kept for five minutes.

In the second embodiment, SrCO₃ contained in the protective layer 25 is exposed to discharge in an oxygen atmosphere and is subjected to the oxygen radical oxidation, and thus transformed to SrO.

The observation of the protective layer 25 after this transforming step has revealed that, similar to the case in the first embodiment in which an O₂ gas is introduced in a state where the protective layer 25 is being heated, almost the entire protective layer 25 is transformed to SrO though SrO₃ slightly remains on a surface of the protective layer 25 in contact with the dielectric layer 17.

More specifically, according to the second embodiment, compared with the case of simply heating and maintaining the protective layer 25, the crystal structure inside the layer can be made stronger. Therefore, sputter resistance of the protective layer 18 (refer to FIG. 1) can be improved, and thus the product life of the PDP 10 (refer to FIG. 1) can be extended.

According to the second embodiment, compared with the first embodiment, the time for keeping the protective layer 25 in a state of being heated can be reduced. Therefore, in addition to the effects described in the first embodiment, the energy required for manufacturing the PDP 10 can be reduced. Also, since the O₂ gas is introduced under an environment at room temperature, manufacturing facilities can be simplified.

Meanwhile, the case where SrCO₃ can be completely transformed to SrO by further extending the time to keep the protective layer 25 in a state of being heated has been described in the first embodiment. It goes without saying that SrCO₃ can be completely transformed to SrO by extending the time to keep the discharge state also in the second embodiment.

As a result of the evaluation of the firing voltage of the PDP 10 obtained by the manufacturing method according to the second embodiment, an initial firing voltage is 180 V, and a relight starting voltage is also 180 V. Furthermore, when the PDP is left unlit at room temperature for one month and then a firing voltage is again evaluated in the same manner as the third comparison example described in the first embodiment, the firing voltage does not fluctuate, that is, remains 180 V.

In other words, it has been found that the PDP 10 (refer to FIG. 1 and FIG. 2) described in the first embodiment can be also obtained by the manufacturing method according to the second embodiment.

### Third Embodiment

In a third embodiment, a method of transforming SrCO₃ to SrO in a manner different from the method according to the first or second embodiment will be described. Note that the difference in structure between a PDP 40 according to the third embodiment and the PDP 10 according to the first embodiment is only in the structure of the protective layer, and the difference in manufacturing process therebetween is only in the transforming step (c3).

Therefore, in the third embodiment, only an enlarged cross-sectional view of the PDP 40 corresponding to FIG. 2 described in the first embodiment is shown, and others will be appropriately described with reference to FIG. 1 to FIG. 6. Furthermore, since the steps other than the transforming step (c3) described in the first embodiment can be applied to the third embodiment, these steps other than the transforming step (c3) are not described herein.

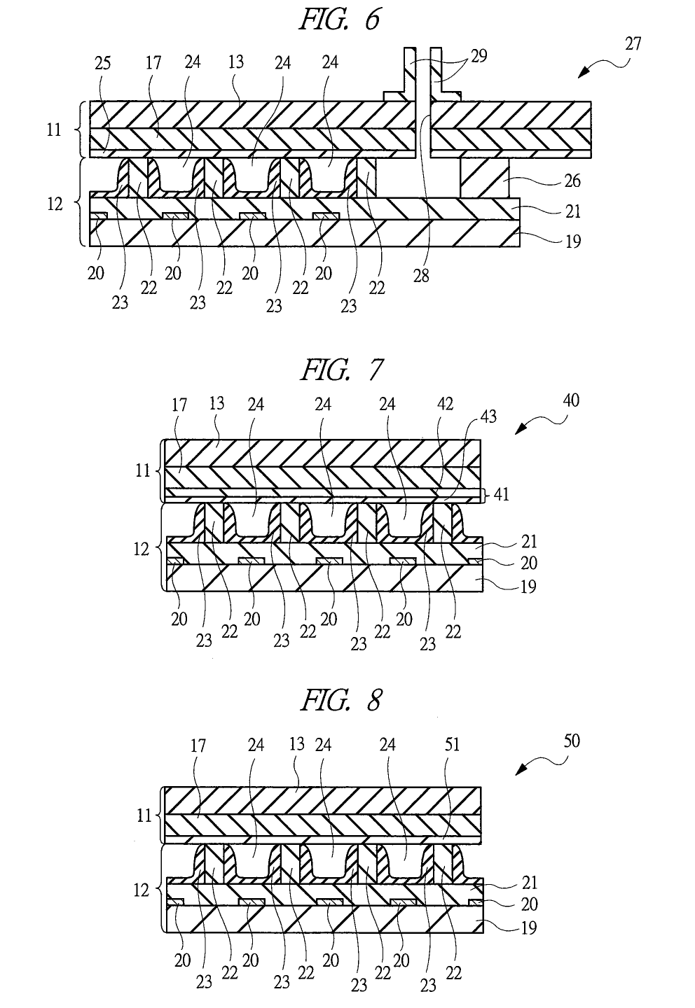

FIG. 7 is an enlarged cross-sectional view of main parts showing the structure of the PDP 40 according to the third embodiment.

In FIG. 7, a protective layer 41 included in the PDP 40 according to the third embodiment has a structure in which a first protective layer 42 made of SrCO₃ and a second protective layer 43 made of SrO are stacked. In the protective layer 41, the first protective layer 42 disposed on a side of a surface in contact with the dielectric layer 17 is made of SrCO₃, and the second protective layer 43 disposed on a side of a surface in contact with the discharge space 24 is made of SrO.

In FIG. 7, in order to clarify the difference from the PDP 10 described in the first embodiment, the protective layer 41 is shown as having a large thickness. However, the thickness of the protective layer 41 is equal to that of the protective layer 18 (refer to FIG. 2) described in the first embodiment, and is, for example, 1 μm.

The first protective layer 42 has a thickness of, for example, 0.7 to 0.8 μm. Also, the second protective layer 43 has a thickness smaller than that of the first protective layer 42 and is, for example, 0.2 to 0.3 μm. However, a boundary between the first protective layer 42 and the second protective layer 43 is not clearly defined. In a boundary area, SrCO₃ and SrO are in a mixed state.

The reason why the protective layer 41 of the PDP 40 has a stacked structure as described above will be described below in conjunction with a manufacturing method of the PDP 40.

In the third embodiment, SrCO₃ contained in the protective layer 25 shown in FIG. 6 is transformed to SrO in the transforming step (c3) in the following manner.

(c3) After the end of the sealing step, the panel structure 27 including the protective layer 25 is cooled to room temperature (for example, 25° C.).

Next, after the remaining gas in the discharge space 24 is exhausted, an oxygen gas containing O₃ (ozone) (mixed gas of O₂ and O₃) is introduced through the ventilation path connected to the tip tube 29. The partial pressure of O₃ contained in the oxygen gas may be lower than that of O₂. This is because an oxidation effect is not significantly changed even if the amount of O₃ is extremely increased. In the third embodiment, an oxygen gas containing O₂ and O₃ at a ratio of partial pressure of 99:1 is introduced at a pressure of 500 torr (approximately 67 kPa), and then the ventilation path connected to the tip tube 29 is temporarily shut off.

Next, the state of the discharge space 24 filled with the oxygen gas containing O₃ is kept for a predetermined time. The state is kept for five minutes in the third embodiment.

In the third embodiment, SrCO₃ contained in the protective layer 25 is exposed to the oxygen gas atmosphere containing O₃, thereby being oxidized and transformed to SrO.

However, since this oxidation is performed under an environment at room temperature, the protective layer 25 is not completely oxidized within the keeping time of five minutes, and the portion exposed to the oxygen gas containing O₃, that is, the surface in contact with the discharge space 24 is transformed to SrO. Therefore, as shown in FIG. 7, the PDP 40 according to the third embodiment has the structure in which the first protective layer 42 made of SrCO₃ and the second protective layer 43 made of SrO are stacked.

As a result of the evaluation of the firing voltage of the PDP 40 obtained by the manufacturing method according to the third embodiment, an initial firing voltage is 180 V, and a relight starting voltage is also 180 V. Furthermore, when the PDP is left unlit at room temperature for one month and then a firing voltage is again evaluated in the same manner as the third comparison example described in the first embodiment, the firing voltage does not fluctuate, that is, remains 180 V.

In other words, it has been found that the PDP 40 obtained by the manufacturing method according to the third embodiment can achieve an effect of reducing the firing voltage similar to that of the PDP 10 (refer to FIG. 1 and FIG. 2) described in the first embodiment.

Also, according to the third embodiment, compared with the first embodiment, the time for keeping the protective layer 25 in a state of being heated can be reduced. Therefore, the PDP 40 can reduce manufacturing energy cost compared with the PDP 10. Furthermore, since the transforming step is performed under an environment at room temperature, manufacturing facilities can be simplified.

However, since the amount of remaining SrCO₃ in the PDP 40 is relatively large compared with the PDP 10, the PDP 10 is thought to have a longer product life than the PDP 40.

### Fourth Embodiment

In a fourth embodiment, a PDP in which the protective layer is made of SrCO₃ will be described. Note that the difference in structure between a PDP 50 according to the fourth embodiment and the PDP 10 according to the first embodiment is only in the material to form the protective layer, and the difference in manufacturing process therebetween is only in that the transforming step (c3) is not performed.

Therefore, in the fourth embodiment, only an enlarged cross-sectional view of the PDP 50 corresponding to FIG. 2 described in the first embodiment is shown, and others will be appropriately described with reference to FIG. 1 to FIG. 6. Furthermore, since the steps other than the transforming step (c3) described in the first embodiment can be applied to the fourth embodiment, these steps other than the transforming step (c3) are not described herein.

FIG. 8 is an enlarged cross-sectional view of main parts showing the structure of the PDP 50 according to the fourth embodiment.

In FIG. 8, a protective layer 51 included in the PDP 50 according to the fourth embodiment is made of SrCO₃. More specifically, the protective layer 51 is formed of a single element of SrCO₃.

Although SrCO₃ has a lower secondary electron emission coefficient compared with SrO, SrCO₃ has a higher secondary electron emission coefficient compared with MgO. As a result of the evaluation of the firing voltage of the PDP 50, an initial firing voltage is 200 V, and a relight starting voltage is also 200 V. Furthermore, when the PDP is left unlit at room temperature for one month and then a firing voltage is again evaluated in the same manner as the third comparison example described in the first embodiment, the firing voltage does not fluctuate, that is, remains 200 V.

In other words, the PDP 50 according to the fourth embodiment can reduce the firing voltage by 10 V (approximately 5%) compared with the first comparison example described in the first embodiment. Therefore, the PDP 50 can reduce power consumption at the time of driving more than the PDP in the first comparison example.

Also, unlike the second and third comparison examples described in the first embodiment, the firing voltage of the PDP 50 is not fluctuated with time. More specifically, the firing voltage can be stably reduced.

The PDP 50 according to the fourth embodiment can be manufactured without performing the transforming step (c3) described in the first embodiment. More specifically, since the steps can be reduced compared with the PDP 10 described in the first embodiment, the manufacturing efficiency can be improved.

### Fifth Embodiment

In a fifth embodiment, a structural example in which the PDP 10, 40 or 50 described in the first to fourth embodiments is incorporated in a plasma display module (hereinafter, referred to as PDP module) or a plasma display apparatus (hereinafter, referred to as PDP apparatus) will be described.

Note that, in the fifth embodiment, examples of the PDP module 100 and the PDP apparatus 200 in which the PDPs 10, 40 and 50 are incorporated are described, and the structure other than the PDPs 10, 40 and 50 described in the first to fourth embodiments is not restricted to that described in the fifth embodiment.

In the fifth embodiment, the PDP module is a module that includes a PDP, a base chassis disposed on a side opposite to a display surface of the PDP and supporting the PDP, and various circuit substrates disposed on a side of a rear surface of the base chassis (surface opposite to a surface facing the PDP) and driving and controlling the PDP module. Also, the PDP apparatus is a display apparatus obtained by covering the PDP module with an outer casing and fixing the PDP module to a supporting structure such as a stand.

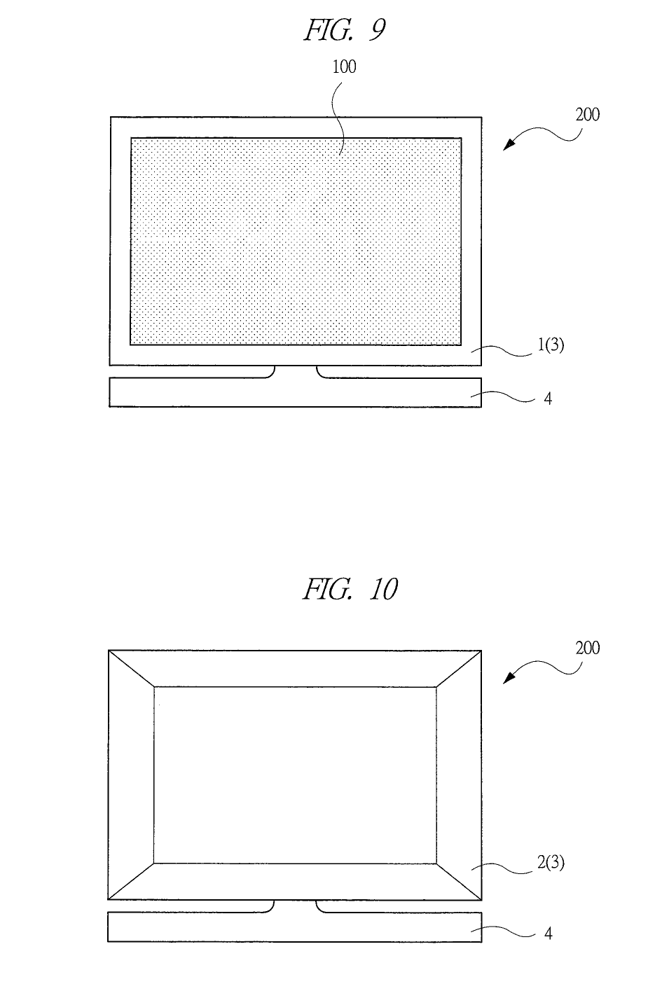

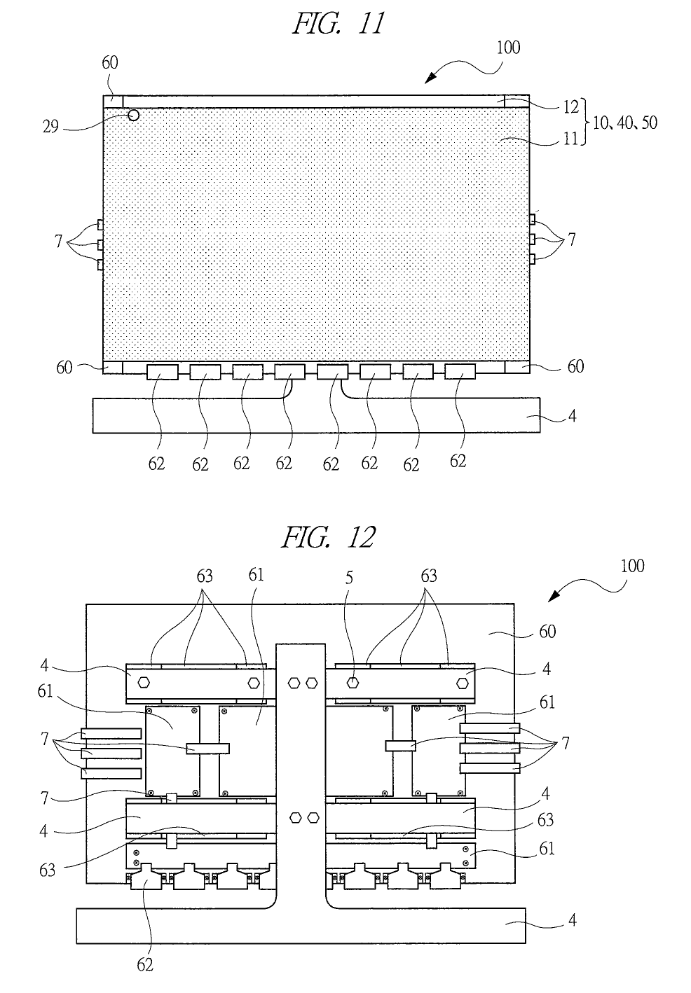

FIG. 9 is a plan view of the PDP apparatus 200 according to the fifth embodiment seen from a display surface side. FIG. 10 is a plan view of the PDP apparatus 200 shown in FIG. 9 seen from a rear surface side. FIG. 11 is a plan view showing the state where a front frame cover 1 is removed from the PDP apparatus 200 shown in FIG. 9.

In FIG. 9 and FIG. 10, the PDP apparatus 200 according to the fifth embodiment has the PDP module 100. Also, the PDP apparatus 200 is provided with an outer casing 3 accommodating this PDP module 100 and composed of the front frame cover 1 and a rear cover 2.

Also, the PDP apparatus 200 is provided with a stand (external supporting structure) 4, which is an external supporting structure, and the PDP module 100 is supported by the stand 4.

Furthermore, as shown in FIG. 11, any of the PDPs 10, 40, and 50 described in the first to fourth embodiments is fixed on the display surface side of the PDP module 100. The PDP 10, 40 or 50 is fixed so that the front structure 11 is disposed on the display surface side.

Still further, the lengths of outer margins of the front structure 11 and the rear structure 12 forming the PDPs 10, 40 and 50 are different from each other, and the front structure 11 and the rear structure 12 are overlapped in a state of partly protruding from each other. Still further, at a corner portion of the area where the front structure 11 and the rear structure 12 are overlapped in a state of being faced with each other, the tip tube 29 described in the first embodiment is disposed with its opening being sealed.

Furthermore, the rear structure 12 side of the PDPs 10, 40 and 50 is fixed to a base chassis 60. As fixing means for fixing the PDPs 10, 40 and 50 to the base chassis 60, for example, an adhesive layer such as a double-faced tape is used so as to tightly fix them.

Next, the structure of a rear side of the PDP module will be described with reference to FIG. 12. FIG. 12 is a plan view showing the state where the rear cover 2 is removed from the PDP apparatus 200 shown in FIG. 10.

In FIG. 12, a plurality of mounting members 63 for fixing the base chassis 60 to the stand 4 which is an outer supporting structure are fixed to this base chassis 60.

The PDP module 100 is supported by fixing the mounting members 63 fixed to the base chassis 60 to the stand 4.

As means for fixing the mounting members to the stand 4, fixing means capable of tight fixing is appropriately selected in order to support the PDP module 100 of heavy weight. For example, through holes are formed in a part of the stand 4 and the mounting members 63, and bolts 5 and nuts (not shown) are used for fixing.

Next, circuits for driving and controlling the PDP module 100 will be described. As shown in FIG. 12, the PDP module 100 is provided with a plurality of circuit substrates 61. Each of the circuit substrates 61 is fixed to the base chassis 60 by screws, for example.

Examples of the circuits of the PDP module 100 include an X drive circuit for applying a voltage to the X electrodes 14 (refer to FIG. 1) of the PDPs 10, 40 and 50, a Y drive circuit for applying a voltage to the Y electrodes 15 (refer to FIG. 1) thereof, an address drive circuit (address relay circuit) for applying a voltage to the address electrodes 20 (refer to FIG. 1) thereof, address driver modules (ADMs) 62, a power supply circuit that supplies power to each component, and a control circuit that controls the entire module including the respective components.

In the PDP module 100, these circuits are formed on the plurality of circuit substrates 61. Which circuit substrate on which these circuits are to be formed can be appropriately changed depending on the layout and the driving method of the PDP module.

Also, in the fifth embodiment, the PDP module 100 is provided with eight ADMs 62, and each of the ADMs 62 has one end electrically connected to the address drive circuit. As shown in FIG. 12, the ADMs 62 extend around the outside of the edge portion of the base chassis 60 to the side of the PDPs 10, 40 and 50 (refer to FIG. 11), and the other end of each ADM 62 is electrically connected to a terminal of the address electrode 20 shown in FIG. 1.

In the fifth embodiment, the address drive circuit and the ADMs 62 are disposed in a lower-side portion of the PDP module 100. However, other structures such as that the address drive circuit and the ADMs 62 are disposed in both upper and lower side portions are also applicable depending on the driving method and others.

Furthermore, other circuit substrates 61 are also connected to the terminals of the PDPs 10, 40 and 50 via wires 7. As these wires 7, flexible substrates such as ADMs 62, band-shaped wires called deformable flat cables and others can be used. Still further, the circuit substrates 61 are electrically connected to each other via the wires 7.

By incorporating the PDPs 10, 40 and 50 described in the first to fourth embodiments in the PDP module 100 or the PDP apparatus 200 described in the fifth embodiment, the PDP module 100 or the PDP apparatus 200 capable of reducing power consumption at the time of driving can be obtained.

In the foregoing, the invention made by the inventor of the present invention has been concretely described based on the embodiments. However, it is needless to say that the present invention is not limited to the foregoing embodiments and various modifications and alterations can be made within the scope of the present invention.

Although the structure in which Ca is contained as an element in the protective layer has been described as a modification example of the first embodiment, it may be applied to the protective layer of the PDP 10 described in the second embodiment or the protective layer of the PDP 40 described in the third embodiment.

In this case, it goes without saying that the sputter resistance of the protective layer is improved.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A manufacturing method of a plasma display panel comprising the steps of:
(a) preparing a first structure having a plurality of first electrodes formed on one surface of a first substrate and a dielectric layer that covers the first electrodes and a second structure having a plurality of second electrodes and a plurality of barrier ribs formed on one surface of a second substrate;
(b) forming a protective layer containing SrCO₃ (strontium carbonate) on a surface of the dielectric layer of the first structure; and
(c) assembling the first structure and the second structure,
wherein the step (c) includes a transforming step of transforming at least a part of SrCO₃ contained in the protective layer to SrO (strontium oxide).

2. The manufacturing method of a plasma display panel according to claim 1,
wherein the step (c) includes a step of sealing the first structure and the second structure in a state where a surface of the first structure where the protective layer is formed and a surface of the second structure where the plurality of barrier ribs are formed are faced with each other, and
the transforming step is performed after the sealing step.

3. The manufacturing method of a plasma display panel according to claim 2,
wherein the transforming step is performed by keeping the protective layer in a state of being heated.

4. The manufacturing method of a plasma display panel according to claim 3,
wherein, in the step (c), after a gas generated when the part of SrCO₃ is transformed to SrO is exhausted, a predetermined discharge gas is filled.

5. The manufacturing method of a plasma display panel according to claim 4,
wherein, in the transforming step, in a state where the protective layer is being heated, an O₂ (oxygen) gas is introduced into a discharge space partitioned by the protective layer and the plurality of barrier ribs.

6. The manufacturing method of a plasma display panel according to claim 2,
wherein the transforming step includes the steps of:
cooling the protective layer; and
after the cooling step, introducing an O₂ (oxygen) gas into a discharge space partitioned by the protective layer and the plurality of barrier ribs, and
a discharge is generated in a state where the O₂ gas is sealed in the discharge space.

7. The manufacturing method of a plasma display panel according to claim 2,
wherein the transforming step is performed by introducing an oxygen gas containing O₃ (ozone) into a discharge space partitioned by the protective layer and the plurality of barrier ribs.

8. The manufacturing method of a plasma display panel according to claim 7,
wherein, in the transforming step, the oxygen gas is introduced after cooling the protective layer.

9. The manufacturing method of a plasma display panel according to claim 2,
wherein the protective layer formed in the step (b) contains Ca (calcium) as an element.

10. A manufacturing method of a plasma display panel comprising the steps of:
(a) preparing a first structure having a plurality of first electrodes formed on one surface of a first substrate and a dielectric layer that covers the first electrodes and a second structure having a plurality of second electrodes and a plurality of barrier ribs formed on one surface of a second substrate;
(b) forming a protective layer made of SrCO₃ (strontium carbonate) on a surface of the dielectric layer of the first structure; and
(c) assembling the first structure and the second structure.

11. A plasma display panel comprising: a first structure and a second structure disposed in a state of being faced with each other,
wherein the first structure includes:
a substrate;
a plurality of electrodes formed on one surface of the substrate;
a dielectric layer that covers the plurality of electrodes; and
a protective layer formed on a surface of the dielectric layer, and
the protective layer contains SrO (strontium oxide) and SrCO₃ (strontium carbonate).

12. The plasma display panel according to claim 11,
wherein the protective layer contains Ca (calcium) as an element.

13. A plasma display panel comprising: a first structure and a second structure disposed in a state of being faced with each other,
wherein the first structure includes:
a substrate;
a plurality of electrodes formed on one surface of the substrate;
a dielectric layer that covers the plurality of electrodes; and
a protective layer formed on a surface of the dielectric layer, and
the protective layer is made of SrCO₃ (strontium carbonate).
